(19) United States
(12) Patent Application Publication
(10) Pub. No.: US 2026/0170310 A1
(43) Pub. Date: Jun. 18, 2026

(54) GENERATIVE AI-BASED DEEP LEARNING MODEL OPTIMIZATION DEVICE AND METHOD OF OPTIMIZING GENERATIVE AI-BASED DEEP LEARNING MODEL FOR REFLECTING ENVIRONMENTAL CHARACTERISTICS USING THE SAME

(71) Applicant: Korea Electronics Technology Institute, Seongnam-si (KR)

(72) Inventors: Kyeong Eun SEO, Seoul (KR); Chang Mo YANG, Goyang-si (KR); Dong Chil KIM, Seoul (KR)

(21) Appl. No.: 19/389,896

(22) Filed: Nov. 14, 2025

(30) Foreign Application Priority Data
Dec. 17, 2024 (KR) 10-2024-0188740

(51) Int. Cl. G06N 3/0475; G06N 3/08

(52) U.S. Cl. CPC G06N 3/0475; G06N 3/08

(57) ABSTRACT

Proposed are a generative AI-based deep learning model optimization device and a method of optimizing a generative AI-based deep learning model for reflecting environment characteristics using the device. The method may include collecting images of surroundings of an installation environment, and generating a condition map based on characteristics of the installation environment. The method may also include training a generative AI model using the collected images based on the condition map, and generating images to be included in a training dataset through the generative AI model. The method may further include optimizing the deep learning model using the generated training dataset.

This application claims priority to and the benefit of Korean Patent Application No. 10-2024-0188740, filed on Dec. 17, 2024, the disclosure of which is incorporated herein by reference in its entirety.

### BACKGROUND

### Technical Field

The present disclosure relates to generative artificial intelligence (AI) technology and deep learning model training optimization, and to a technology for generating training data for a deep learning model using a generative AI model and causing the deep learning model to be effectively trained using this training data.

### Description of Related Technology

Generative AI is used to generate training data for deep learning models and artificial neural networks in various fields. Generative AI generates data according to a user intent, and the generated data is used to train the deep learning model, thereby optimizing the deep learning model.

### SUMMARY

One aspect is to automatically generate an optimized dataset necessary for training of a deep learning model by reflecting characteristics of an installation environment of a device using the deep learning model, thereby maximizing the performance of the deep learning model.

Another aspect is to generate training data tailored to an installation environment using generative AI and optimize a process of training a deep learning model based on the generated training data, thereby providing highly reliable performance in a real environment.

The present disclosure is not limited to those aspects described herein, and other aspects that are not mentioned will be clearly understood by those skilled in the art from the following description.

Another aspect is a method of optimizing generative AI-based deep learning model for reflecting environment characteristics using a generative AI-based deep learning model optimization device. The method includes collecting images of surroundings of an installation environment; generating a condition map based on characteristics of the installation environment; training a generative AI model using the collected images based on the condition map; generating images to be included in a training dataset through the generative AI model; and optimizing the deep learning model using the generated training dataset.

Another aspect is a device for optimizing a generative AI-based deep learning model for reflecting environment characteristics. The device includes a memory configured to store one or more instructions; and a processor configured to execute the instructions, wherein when the instructions are executed, the processor is configured to collect images of surroundings of an installation environment, generate a condition map based on characteristics of the installation environment, train a generative AI model using the collected images based on the condition map, generate images to be included in a training dataset through the generative AI model, and optimize the deep learning model using the generated training dataset.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a diagram illustrating a method of optimizing a generative AI-based deep learning model for reflecting environment characteristics according to an embodiment.

FIG. 2 is a diagram illustrating a process of collecting images of surroundings of an installation environment in the method of optimizing a generative AI-based deep learning model for reflecting environment characteristics according to the embodiment.

FIGS. 3A and 3B are diagrams illustrating a method of analyzing environmental similarity in the method of optimizing a generative AI-based deep learning model for reflecting environment characteristics according to the embodiment.

FIGS. 4A to 4C illustrate an example of condition map generation results in the method of optimizing a generative AI-based deep learning model for reflecting environment characteristics according to the embodiment.

FIG. 5 illustrates a learning structure of a generative AI model in a device for optimizing a generative AI-based deep learning model for reflecting environment characteristics according to the embodiment.

FIG. 6 illustrates a process in which a condition map generator generates a condition map.

FIG. 7 illustrates an operating algorithm of the condition map generator.

FIG. 8 is a diagram illustrating a process of generating a generative AI training dataset based on installation environment characteristics in the device for optimizing a generative AI-based deep learning model for reflecting environment characteristics according to the embodiment.

FIG. 9 is a diagram illustrating a process of generating generative AI data based on variability analysis in the device for optimizing a generative AI-based deep learning model for reflecting environment characteristics according to the embodiment.

FIG. 10 is a block diagram illustrating a generative AI-based deep learning model optimization device according to the embodiment of the present disclosure.

### DETAILED DESCRIPTION

Recently, a technology for adding conditions (for example, a condition map) to a generative AI model to generate data based on a user intent (Adding Conditional Control to Text-to-Image Diffusion Models, ICCV 2023) has been introduced. Examples of a condition map additionally used together with text input of a user include a skeleton and a Canny edge. There is an advantage that the added conditions provide information difficult to represent with existing text input.

However, an existing deep learning model is typically trained on a standardized dataset, making it difficult to reflect various variabilities occurring in a real installation environment of a device using the deep learning model. Further, in an installation environment such as a CCTV surveillance camera, datasets tailored to characteristics or conditions required by a user are insufficient, limiting optimal performance.

It should be noted that the technical terms used herein are used merely to describe specific embodiments and are not intended to limit the technical spirit of the present disclosure. Further, the technical terms used herein should be construed in the sense generally understood by those skilled in the art and should not be construed in an overly broad or overly narrow sense. Further, when a technical term used herein is an incorrect technical term failing to accurately express the technical spirit of the present disclosure, the term should be replaced with a technical term that can be correctly understood by those skilled in the art. Further, general terms used herein should be construed according to dictionary definitions or according to the context, and should not be construed in an excessively narrow sense.

The embodiments disclosed herein will be described in detail with reference to the accompanying drawings. The same or similar components will be denoted by the same reference numerals throughout the drawings, and redundant description thereof will be omitted. Suffixes “module” and “unit” of components used in the following description are assigned or used interchangeably solely for the convenience of writing the specification, and do not inherently have distinct meanings or functions. Further, the accompanying drawings are intended only to facilitate understanding of the embodiments disclosed herein, the technical spirit disclosed herein is not limited by the accompanying drawings, and it should be understood that all modifications, equivalents, and alternatives included in the spirit and technical scope of the present disclosure are encompassed.

Further, terms including ordinal numbers, such as “first” and “second,” used herein may be used to describe various components, but the components should not be limited by these terms. These terms are used solely to distinguish one component from another. For example, a first component may be referred to as a second component without departing from the scope of the present disclosure, and similarly, a second component may also be referred to as a first component.

When a component is referred to as being “connected” or “coupled” to another component, the component may be directly connected or coupled to the other component, but there may also be other intervening components. On the other hand, when a component is referred to as being “directly connected” or “directly coupled” to another component, it should be understood that there are no other intervening components.

Singular expressions include plural expressions unless the context clearly indicates otherwise.

It should be understood that, in the present application, terms such as “include” and “have” are intended to designate the presence of a feature, number, step, operation, component, part, or combination thereof described in the specification, but do not preclude the possibility of the presence or addition of one or more other features, numbers, steps, operations, components, parts, or combinations thereof.

Videos or images according to an embodiment of the present disclosure include both still images and moving images unless otherwise specified.

The embodiment disclosed in the present specification relates to optimization of a generative AI-based deep learning model for reflecting environment characteristics, and proposes a method of optimizing a deep learning model by utilizing conditions (such as a condition map) generated in consideration of characteristics of an installation environment of a device using a deep learning model like an intelligent surveillance camera, for training of a generative AI model, constructing training data based on images generated through generative AI, and training the deep learning model using the training data.

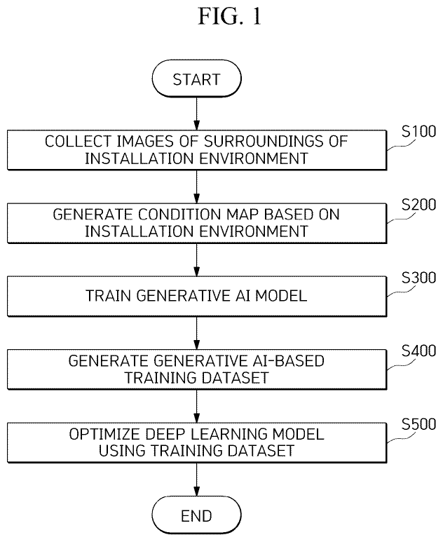

FIG. 1 is a diagram illustrating a method of optimizing a generative AI-based deep learning model for reflecting environment characteristics according to an embodiment.

Referring to FIG. 1, a method of optimizing a generative AI-based deep learning model for reflecting environment characteristics according to an embodiment may be achieved by performing a process to be described below using a generative AI-based deep learning model optimization device.

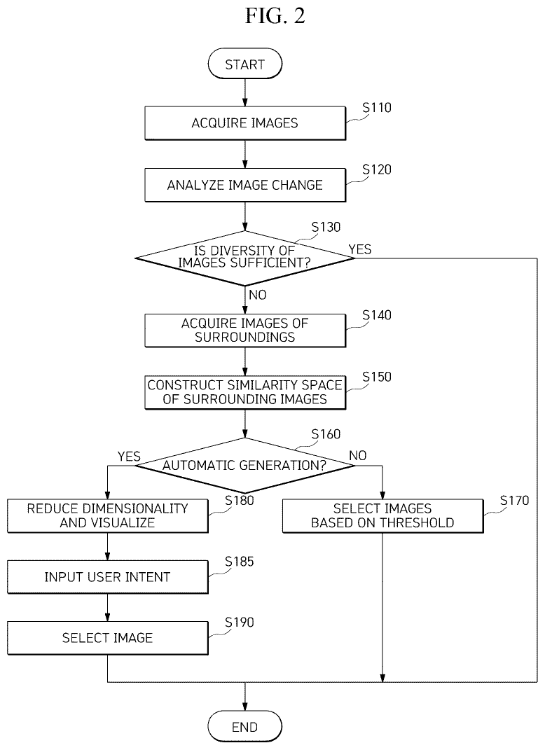

First, the generative AI-based deep learning model optimization device collects images of the surroundings of the installation environment (S100). An overall procedure for collecting the images of the surroundings of the installation environment is as illustrated in FIG. 2.

FIG. 2 is a diagram illustrating a process of collecting the images of the surroundings of the installation environment in the method of optimizing a generative AI-based deep learning model for reflecting environment characteristics according to the embodiment.

Referring to FIG. 2, images of a surrounding environment are first collected from an installed surveillance camera (S110). In this case, the surveillance camera captures images in various environments to collect a dataset of various images. Next, similarity analysis of the collected images, that is, image change analysis, is performed (S120) to analyze a similarity space configuration. After the image change analysis is performed, it is determined whether the diversity of the images is sufficient (S130), the image collection is stopped when the diversity of the images is sufficient (S130→Yes), and additional images of the surrounding environment are collected through surveillance cameras installed in the surroundings when the diversity of the images is not sufficient (S130→No) (S140). When the images are collected, environmental similarity is analyzed, that is, a similarity space of surrounding images is constructed (S150). Methods of analyzing the environmental similarity include a manual method and an automatic method, when it is determined by the method of analyzing the environmental similarity (S160) that the method is the automatic generation method (S160→Yes), images are selected based on a threshold (S170), and when it is determined that the method is the manual generation method (S160→No), dimensionality reduction and visualization are performed (S180), user intent is input (S185), and then images are selected (S190).

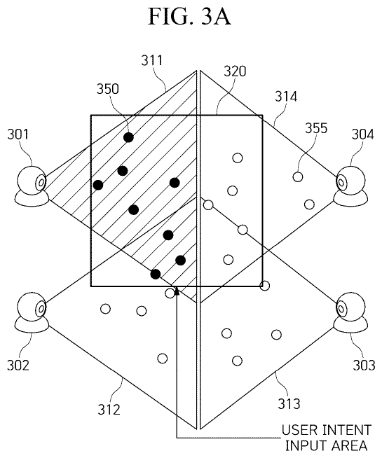

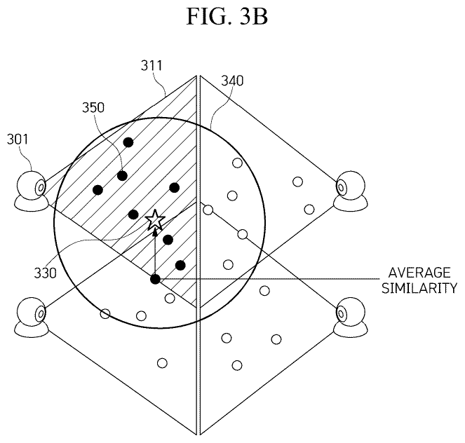

A detailed process of the method of analyzing environmental similarity will be described with reference to FIGS. 3A to 3B.

FIGS. 3A to 3B are diagrams illustrating a method of analyzing environmental similarity in the method of optimizing a generative AI-based deep learning model for reflecting environment characteristics according to the embodiment.

In FIGS. 3A to 3B, visualization results according to dimensionality reduction and the automatic method and the manual method utilizing the results are illustrated. Referring to FIGS. 3A to 3B, a surveillance area of a surveillance camera of interest 301 is indicated by 311, and surveillance areas of nearby cameras 302, 303, and 304 are indicated by 312, 313, and 314, respectively. Black dots 350 represent images captured by the surveillance camera of interest 301, and white dots 355 represent images captured by the nearby surveillance cameras 302, 303, and 304.

FIG. 3A is a diagram illustrating a manual image selection method, and the manual method includes providing a user with results of similarity space analysis through dimensionality reduction and visualization, and selecting images that the user desires to use. In this case, the user sets an intended input area 320 and selects desired images within the input area. FIG. 3B is a diagram illustrating the automatic method, and an automatic image selection method includes selecting images within a threshold distance 340 set from an average similarity 330 of images (the black dots 350) acquired in an installation environment (surveillance area 311) of the surveillance camera of interest 301.

Referring back to FIG. 1, the generative AI-based deep learning model optimization device then generates a condition map reflecting characteristics of the installation environment (S200).

The generative AI-based deep learning model optimization device analyzes the collected images and generates a condition map reflecting primary characteristics of an environment in advance to construct a set. This map may visually represent the variability and characteristics of the installation environment. Elements constituting the condition map include semantic segmentation, a Canny edge, a depth image, a bounding box, and a skeleton.

Condition information for generating a condition map based on an optimization model and an installation environment is generated. Semantic segmentation, a Canny edge, a depth image, object detection, and skeleton information are generated for all image sets as condition maps.

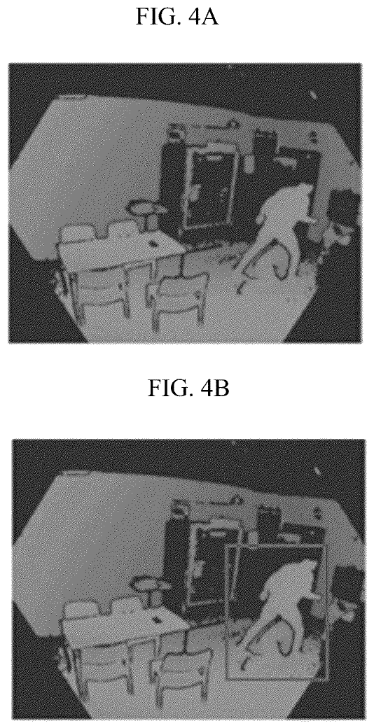

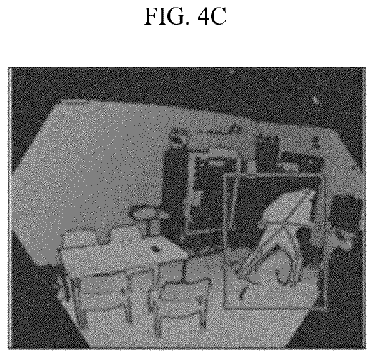

FIGS. 4A to 4C illustrate an example of condition map generation results in the method of optimizing a generative AI-based deep learning model for reflecting environment characteristics according to the embodiment.

FIG. 4A illustrates an example of the depth image, and FIG. 4B illustrates an example of the depth image and object detection. A detected object is indicated by a bounding box. FIG. 4C illustrates an example of the depth image, the object detection, and a skeleton. For the detected object indicated by the bounding box, the skeleton is indicated.

Based on generated condition information, a condition distribution for surroundings of the installation environment is defined. The condition distribution is calculated for each element. A semantic segmentation distribution is calculated based on information on the number of areas and the number of classes, the depth image is calculated based on the number of areas and a depth value, and the object detection is calculated based on sizes of objects, the number of objects, and a class distribution value. The skeleton information is calculated based on a size of the skeleton, the number of objects, and the class distribution value.

Referring back to FIG. 1, the generative AI-based deep learning model optimization device then trains the generative AI model (S300).

The generative AI model has a model structure that generates images using the condition map. The generative AI model using the condition map operates by controlling spatial information in the image that is generated using the condition map in a general generative AI model. The condition map is generated by a condition map generator. The condition map generator serves to dynamically change the condition map during a learning process.

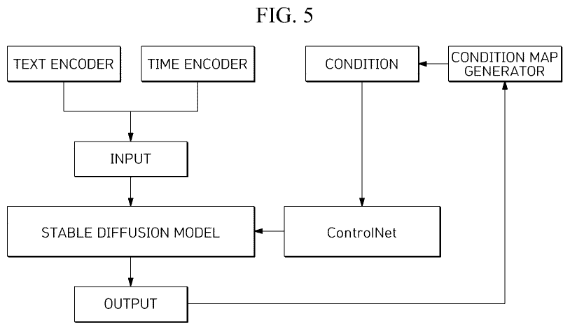

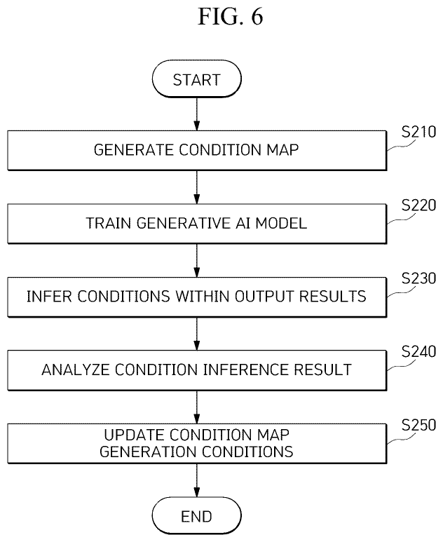

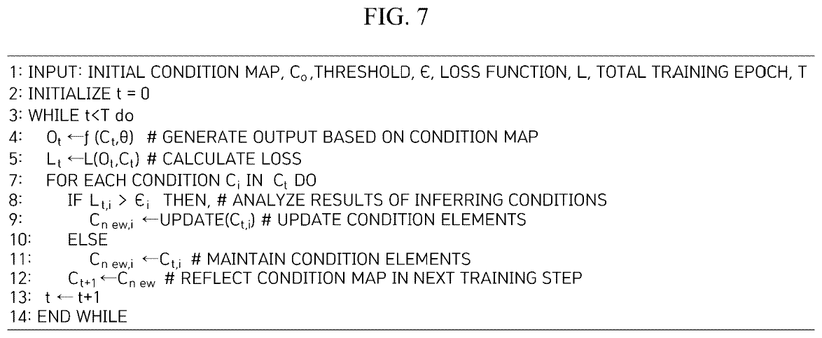

FIG. 5 illustrates a learning structure of the generative AI model in the device for optimizing a generative AI-based deep learning model for reflecting environment characteristics according to the embodiment, and FIG. 6 illustrates a process in which the condition map generator generates a condition map.

An operation process of the condition map generator is the same as an execution procedure of the condition map generator.

Referring to FIGS. 5 and 6, when the condition map generator generates the condition map (S210), the generated condition map is input to a ControlNet, and the ControlNet trains the generative AI model so that output is generated according to conditions of the condition map (S220). Thereafter, in a condition inference operation (S230), a result of calculating a loss value based on an output of the generative AI model is verified. Based on a loss value calculated for each element, a case in which the loss value is higher than a threshold is verified. In a condition analysis operation (S240), when the loss value is higher than the threshold, the conditions are verified and a condition for reflecting a relevant element in condition map conditions is reset. In an operation of updating condition map generation conditions (S250), conditions are reflected so that the condition map is generated with a reset condition.

FIG. 7 illustrates an operating algorithm of the condition map generator.

A loss function L for generative AI model learning is as shown in Formula 1. In Formula 1, w represents a weight, L represents an individual loss function, w_{diff}L_{diff} represents a weight and a loss value for a result of generating the image in the generative AI model, wₛᵢₘLₛᵢₘ represents a weight and a loss value for installation environment image generation results, w_{seg}L_{seg} represents a weight and a loss value for semantic segmentation conditions, w_{dep}L_{dep} represents a weight and a loss value for depth image conditions, w_{obj}L_{obj} represents a weight and a loss value for object detection conditions, and wₛₖᵢLₛₖᵢ represents a weight and a loss value for a skeleton.

$$L = {w}_{diff} {L}_{diff} + {w}_{sim} {L}_{sim} + {w}_{seg} {L}_{seg} + {w}_{dep} {L}_{dep} + {w}_{obj} {L}_{obj} + {w}_{skl} {L}_{skl} \qquad FORMULA 1$$

Formula 2 represents an installation environment weighted loss function Lₛᵢₘ, and Lₛᵢₘ is included in the loss value by adding a weight to the installation environment image generation result. In Formula 2, Mᵢ represents a mask value (1 for the installation environment image and 0 for other images, and N_{data} represents an environment image dataset.

$${L}_{s i m} = {\sum }_{i = 1}^{{N}_{data}} {M}_{i} \times {L}_{diff} \qquad FORMULA 2$$

Formula 3 represents a semantic segmentation condition loss function L_{seg}, and L_{seg} is defined based on a pixel-based probability distribution according to the number of semantic segmentation areas and the number of classes. In Formula 3, for R areas and C classes, a difference between a true distribution Pₜᵣᵤₑ(R, Cⱼ) and a generated distribution P_{pred}(R, Cⱼ) is calculated.

$${L}_{s e g} = {\sum }_{R} {\sum }_{{C}_{j}} {P}_{true} ( R , {C}_{j} ) log \frac{{P}_{t r u e} ( R , {C}_{j} )}{{P}_{p r e d} ( R , {C}_{j} )} \qquad FORMULA 3$$

Formula 4 represents a depth image condition loss function L_{dep}, and L_{dep} is defined based on a distribution of depth values for each area. In Formula 4, for R areas, a difference between a true depth value distribution Pₜᵣᵤₑ(R,Dₖ) and a generated distribution P_{pred}(R,Dₖ) is calculated for a depth value Dₖ.

$${L}_{dep} = {\sum }_{R} {\sum }_{{D}_{k}} {P}_{true} ( R , {D}_{k} ) log \frac{{P}_{t r u e} ( R , {D}_{k} )}{{P}_{p r e d} ( R , {D}_{k} )} \qquad FORMULA 4$$

Formula 5 represents an object detection condition loss function L_{obj}, L_{obj} is defined by analyzing the object detection conditions and combining a size of the object S, the number of objects O, and a distribution of classes C, and for the size of the object, the number of the objects, and the classes, a difference between a true object distribution Pₜᵣᵤₑ(S,O,Cⱼ) and a generated object distribution P_{pred}(S,O,Cj) is calculated.

$${L}_{obj} = {\sum }_{S} {\sum }_{O} {\sum }_{{C}_{j}} {P}_{true} ( S , O , {C}_{j} ) log \frac{{P}_{true} ( S , O , {C}_{j} )}{{P}_{pred} ( S , O , {C}_{j} )} \qquad FORMULA 5$$

Formula 6 represents an object detection condition loss function Lₛₖᵢ, Lₛₖᵢ is used to analyze skeleton conditions, and the skeleton conditions are defined by combining a size of the skeleton object Sₛ, the number of skeleton objects Oₛ, and a distribution of a class of the skeleton Cₛ, similar to the object detection conditions. For the size of the skeleton, the number of skeletons, and the class of the skeleton, a difference between a true object distribution Pₜᵣᵤₑ(Sₛ,Oₛ,C_{s,j}) and a generated object distribution P_{pred}(Sₛ,Oₛ,C_{s,j}) is calculated.

$${L}_{skl} = {\sum }_{{S}_{s}} {\sum }_{{O}_{s}} {\sum }_{{C}_{s , j}} {P}_{t r u e} ( {S}_{{s}^{,}} {O}_{s} , {C}_{s , j} ) log \frac{{P}_{true} ( {S}_{s} , {O}_{s} , {C}_{s , j} )}{{P}_{pred} ( {S}_{s} , {O}_{s} , {C}_{s , j} )} \qquad FORMULA 6$$

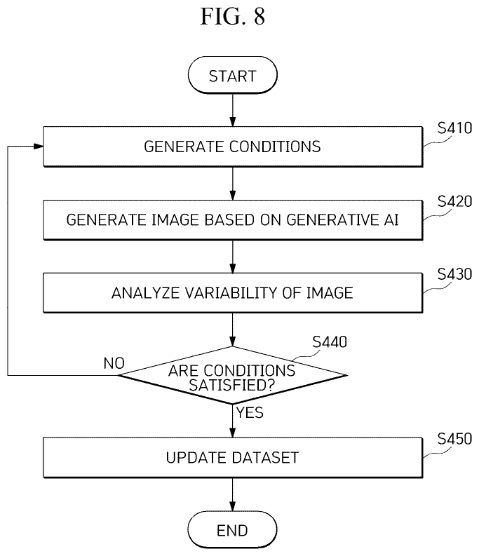

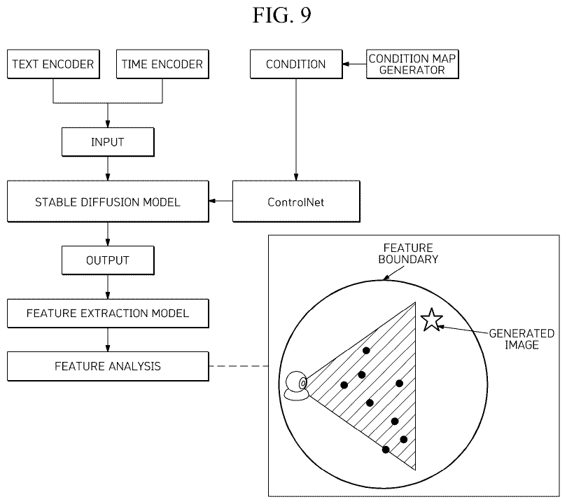

Referring back to FIG. 1, the generative AI-based deep learning model optimization device then generates a generative AI-based training dataset (S400). The generative AI-based deep learning model optimization device generates a training dataset to be used for deep learning model optimization using a trained generative AI model, and this will be described in detail hereinafter with reference to FIGS. 8 and 9.

FIG. 8 is a diagram illustrating a process of generating a generative AI training dataset based on installation environment characteristics in the device for optimizing a generative AI-based deep learning model for reflecting environment characteristics according to the embodiment.

Referring to FIG. 8, text information and conditions are generated in the generative AI model for creation of a dataset required for a target deep learning model (S410), and an image is generated using the generative AI model (S420). The variability of the resulting image generated by the generative AI model is then analyzed (S430). It is determined whether variability analysis conditions are satisfied (S440), the image is stored in the training dataset to update the dataset when the variability analysis conditions are satisfied (S440→Yes) (S450), and the process returns to the condition generation operation when the variability analysis conditions are not satisfied (S440→No) (S410).

FIG. 9 is a diagram illustrating a process of generating generative AI data based on variability analysis in the device for optimizing a generative AI-based deep learning model for reflecting environment characteristics according to the embodiment.

Referring to FIG. 9, a detailed process of generating the generative AI data is as follows. Conditions are generated using installation environment distribution information, and an image is generated using a stable diffusion model, which is a generative AI model, based on the generated conditions. Next, features of the generated image are extracted using a deep learning-based feature extraction model, and a dimensionality of the extracted features is then reduced to perform feature analysis through variability analysis against an existing installation environment. In this case, a feature boundary, which is a variable area, is set in advance, analysis is performed to determine whether the generated image falls within the feature boundary set in advance, and the generated image is included in the dataset when the generated image falls within the feature boundary.

Referring back to FIG. 1, the generative AI-based deep learning model optimization device optimizes the deep learning model using the generated dataset (S500). This process is an operation of optimizing the deep learning model using the dataset generated by the generative AI model, and in this case, the deep learning model is trained again using learning parameters. In a training process, the performance of the model is periodically evaluated through validation data, and when further performance improvement is required, the generative AI-based training dataset generation process S400 is performed again to secure an additional dataset.

Hereinafter, a configuration of the generative AI-based deep learning model optimization device according to the embodiment will be described.

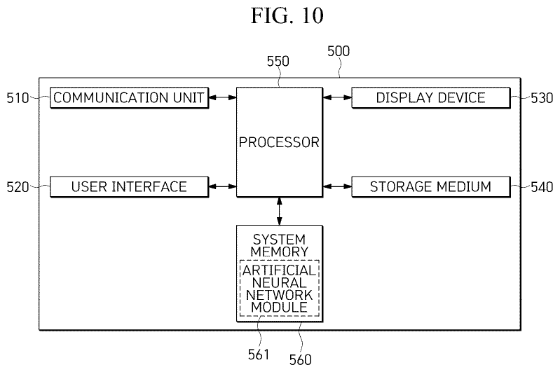

FIG. 10 is a block diagram illustrating the generative AI-based deep learning model optimization device according to the embodiment of the present disclosure.

Referring to FIG. 10, the generative AI-based deep learning model optimization device 500 includes a communication unit 510, a user interface device 520, a display device 530, a storage medium 540, a processor 550, and a system memory 560, enabling functions of the generative AI-based deep learning model optimization device described above to be performed.

The communication unit 510 may transmit and receive signals to and from video capturing devices other than the generative AI-based deep learning model optimization device 500 and the surveillance camera of interest via a network.

The user interface device 520 receives user input for controlling operations of the generative AI-based deep learning model optimization device 500 or the processor 550. The user interface device 520 may include a key pad, a dome switch, a touch pad (a resistive/capacitive touch pad), a jog wheel, a jog switch, a finger mouse, and the like.

The display device 530 operates under the control of the processor 550. The display device 530 displays information processed by the generative AI-based deep learning model optimization device 500 or the processor 550. For example, the display device 530 may display an image under the control of the processor 550.

The storage medium 540 may be at least one of a flash memory, a hard disk, a solid state disk (SSD), a multimedia card memory, a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. The storage medium 540 is configured to write and read data under the control of the processor 550.

The processor 550 may include any one of a general-purpose and dedicated processor, and controls operations of the communication unit 510, the user interface device 520, the display device 530, the storage medium 540, and the system memory 560.

The processor 550 is configured to load program codes including instructions for providing various functions when the program codes are executed from the storage medium 540 into the system memory 560 and execute the loaded program codes. The processor 550 may load an artificial neural network module 561 including instructions and/or program codes from the storage medium 540 into the system memory 560 and execute the loaded artificial neural network module 561. The artificial neural network module 561 may display images and/or videos received from another external terminal on the display device 530 to detect related user input. Further, the artificial neural network module 561 may visualize an additional user interface on the display device 530 to detect user input.

The processor 550 may implement all the functions of the generative AI-based deep learning model optimization device 500 described above, and all processes of a control method in the generative AI-based deep learning model optimization device 500 through the artificial neural network module 561 or through the program loaded from the storage medium 540.

The processor 550 transmits the optimized deep learning model through the communication unit 510 to a target device (e.g., a camera, a surveillance camera, a security system, an air conditioning system, a facility management system, a risk recognition and response system) that must recognize and respond to the environment, thereby causing the target device to operate using the deep learning model.

For example, the deep learning model may be a security intelligence model, and the target device may be a security system. In this case, the security system inputs images collected by a surveillance camera into the deep learning model, uses the deep learning model to detect objects and determine situations, and performs actions such as blocking doors, issuing an alarm, or sending messages to the mobile terminals of interested parties, based on the object detection results or situation determination results generated as a result of the deep learning model's inference.

The system memory 560 may be provided as a working memory of the processor 550. In the drawing, the system memory 560 is illustrated as a separate component from the processor 550, but this is merely illustrative and at least a portion of the system memory 560 may be integrated within the processor 550. The system memory 560 may include at least one of a RAM, a ROM, and any other type of computer-readable storage medium.

The embodiments described above are combinations of components and characteristics of the present disclosure in predetermined forms. Each component or characteristic should be considered optional unless explicitly stated otherwise. Each component or characteristic may be implemented in a form in which there is no combination with other components or characteristics. Further, it is also possible to configure the embodiments of the present disclosure by combining some components and/or characteristics. An order of operations described in the embodiments of the present disclosure may be changed. Some components or characteristics of a certain embodiment may be included in another embodiment, or may be replaced with corresponding components or characteristics of another embodiment. It is obvious that claims that do not have an explicit citation relationship in the claims may be combined to form an embodiment or included as new claims by amendment after filing.

The embodiments according to the present disclosure may be implemented by various means, for example, hardware, firmware, software, or a combination thereof. When an embodiment of the present disclosure is implemented by hardware, the embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

When an embodiment of the present disclosure is implemented by firmware or software, the embodiment of the present disclosure may be implemented in the form of a module, procedure, function, or the like that performs the functions or operations described above. Software code may be stored in a memory and driven by a processor. The memory may be located inside or outside the processor and may exchange data with the processor by various means that are already known.

According to the embodiments disclosed herein, it is possible to generate training data tailored to an installation environment using generative AI and optimize a process of training a deep learning model based on the generated training data, thereby providing highly reliable performance in a real environment.

Further, according to the embodiments disclosed herein, it is possible to collect customized datasets optimized for a specific situation.

Further, according to the embodiments disclosed herein, it is possible to generate training data that systematically reflects various environmental factors by utilizing a condition map in a generative AI model.

Further, according to the embodiments disclosed herein, it is possible to generate a deep learning model that is robust to environmental variability, thereby providing high reliability.

The effects of the present disclosure are not limited to those described above, and other effects that are not mentioned will be clearly understood by those skilled in the art from the above description.

It will be obvious to those skilled in the art that the present disclosure can be embodied in other specific forms without departing from essential characteristics of the present disclosure. Therefore, the detailed description described above should not be construed as limiting and should be considered as illustrative in all aspects. The scope of the present disclosure should be determined by a reasonable interpretation of the appended claims, and all changes within the equivalent scope of the present disclosure are included in the scope of the present disclosure.

What is claimed is:

1. A method of optimizing a generative AI-based deep learning model for reflecting environment characteristics using a generative AI-based deep learning model optimization device, the method comprising:
collecting images of surroundings of an installation environment;
generating a condition map based on characteristics of the installation environment;
training a generative AI model using the collected images based on the condition map;
generating images to be included in a training dataset through the generative AI model;
optimizing the deep learning model using the generated training dataset; and
transmitting the deep learning model to a target system, which recognizes and responds to environment using the deep learning model.

2. The method of claim 1, wherein the collecting comprises:
acquiring images of the installation environment;
analyzing one or more changes in the acquired images;
determining whether diversity of the images is sufficient based on the changes in the acquired images;
collecting no more images when it is determined that the diversity of images is sufficient, and collecting images of the surroundings of the installation environment in response to determining that the diversity of images is insufficient; and
selecting a training dataset from among the collected images based on similarity space analysis results for the images of the surroundings of the installation environment.

3. The method of claim 2, wherein the selecting comprises:
reducing a dimensionality of the similarity space analysis results and visualizing the dimensionality;
setting a user intent input area in the installation environment; and
selecting images within the user intent input area as the training dataset.

4. The method of claim 2, wherein the selecting comprises:
calculating an average similarity of images acquired from the installation environment; and
selecting images within a predetermined value from the average similarity as the training dataset.

5. A device for optimizing a generative AI-based deep learning model for reflecting environment characteristics, the device comprising:
a memory configured to store one or more instructions; and
a processor configured to execute the instructions to:
collect images of surroundings of an installation environment,
generate a condition map based on characteristics of the installation environment,
train a generative AI model using the collected images based on the condition map,
generate images to be included in a training dataset through the generative AI model,
optimize the deep learning model using the generated training dataset, and
transmit the deep learning model to a target system, which recognizes and responds to environment using the deep learning model.

6. The device of claim 5, wherein the processor is configured to:
acquire images of the installation environment, analyze one or more changes in the acquired images, and determine whether diversity of the images is sufficient based on the one or more changes in the acquired images;
collect no more images when it is determined that the diversity of images is sufficient, and collect images of the surroundings of the installation environment in response to determining that the diversity of images is insufficient; and
select a training dataset from among the collected images based on similarity space analysis results for the images of the surroundings of the installation environment.

7. The device of claim 6, wherein the processor is configured to:
reduce a dimensionality of the similarity space analysis results and visualize the dimensionality;
set a user intent input area in the installation environment; and
select images within the user intent input area as the training dataset.

8. The device of claim 6, wherein the processor is configured to:
calculate an average similarity of images acquired from the installation environment; and
select images within a predetermined value from the average similarity as the training dataset.
